(19) United States
(12) Patent Application Publication
(10) Pub. No.: US 2002/0063889 A1
(43) Pub. Date: May 30, 2002

(54) Printing system, image capturing apparatus, print service reception processing apparatus, print service administration apparatus, print processing apparatus, memory media, print service method, print service reception processing method, print service administration method and print processing method

(76) Inventors: Kazuhoro Takemoto, Tokyo (JP); Iwao Aizawa, Tokyo (JP); Takashi Igarashi, Tokyo (JP)

Correspondence Address: CANTOR COLBURN LLP, 55 Griffin Road South, Bloomfield, CT, 06002, US

(21) Appl. No.: 09/989,211

(22) Filed: Nov. 20, 2001

(30) Foreign Application Priority Data
Nov. 24, 2000 (JP) 357100/2000

(51) Int. Cl. B41B 1/00; G06F 15/00

(52) U.S. Cl. 358/1.15; 358/1.6

(57) ABSTRACT

A data printing system, including: a digital camera or other image capturing device, including a memory for storing individual unit identification information of the image capturing device; a print service administration device, connected to a network, for administering image data printing and for receiving image data recorded by the image capturing device; and a printer or other print processing device, connected to the network, for executing a printing process in accordance with an instruction from the print service administration device. In the data printing system, the individual unit identification information and the image data are transmitted from the image capturing device to the print service administration device; and the printing process by the print processing device is administered by establishing a logical linkage between the individual unit identification information and the image data.

### BACKGROUND OF THE INVENTION

The present invention relates to a system for performing print operations based on print orders, more particularly to a printing system capable of receiving print orders easily.

In recent years, digital cameras and home-use digital printers have been rapidly proliferating, thanks to improvement in image processing technology. Along with this, actual users' knowledge and understanding of the usefulness of digital images are also becoming deeper and these products are coming to be used in various applications such as creating Internet homepages and printing digital data. In the meantime, the image output centers and mini-labs (small-scale photofinishing laboratories) providing an image print service, and large-volume labs with centralized processing capabilities are also naturally increasing as service providers who handle digital image data, and variations of digital image data services are diversified.

It is known, as an example of such digital image data services, that at a photo shop, the customer, after uploading the image data of a negative film into a server made open on the Internet, can make requests for reprints and place an order for a premium such as an image-printed mugcup or T-shirt, based on the authentication information preassigned to that customer only. Customers who are permitted to view image data can also receive a similar service.

Japanese Patent Application Publication No. Hei-11-134124 (1999), for example, describes a print order receiving system that is provided with an apparatus by which the desired image data is read out from removable media containing various image data, and with a touchpanel on which images are displayed on the basis of the image data that has thus been read out, and then the image to be printed can be selected from the displayed images.

Also, Unexamined Japanese Patent Application Specification No. 2000-112964 describes an information supply terminal system by which the operator who enters original images can be identified, then after confirming via a display unit the display status of the original images acquired from an image input unit, the user-intended image can be transferred to and registered in an information supply server, and the hypertext managed by a memory unit can be automatically updated so as to enable the registered image to be retrieved.

Unexamined Japanese Patent Application Specification No. 2000-235642 describes an image processing system that can, after issuing a unique user ID and a unique password to the user, acquire from a memory unit the user area corresponding to the user ID, then judge from the user ID and the password whether the user is an authorized user, and permits only this authorized user to process the image data contained in the directory corresponding to the user ID.

In the services mentioned above, it has been necessary to issue either a slip or an order receiving ID when receiving a print order, and thus to enter the order receiving ID in order to hand over the prints to the user in exchange for either the slip or the order receiving ID and/or access the server area on the Internet where the intended image data is stored.

However, it has been troublesome to control the above-mentioned order receiving ID or slip until the prints were handed over to the user, and the loss of prints or failure to receive print orders has frequently occurred.

### SUMMARY OF THE INVENTION

In view of these problems associated with the prior art, it is the object of the present invention to provide a printing system, and various apparatus/methods used for the printing system, that is capable of simplifying the reception and processing of the print orders for the images which have been captured using, for example, digital cameras.

The above-described object of the present invention can be fulfilled using a printing system in which

an image capturing apparatus for capturing and registering image data,

a print service administration apparatus for administering the printing of the image data which has been recorded by said image capturing apparatus,

a print service reception processing apparatus for uploading said image data into a center server, and

a print processing apparatus for printing the image data in accordance with instructions from said print service administration apparatus are connected via a network and said printing system is characterized in that

said image capturing apparatus has a means for storing the individual unit identification information of the image capturing apparatus, and in that the print service administration apparatus administers said printing operations by establishing logical linkage between the individual unit identification information of the image capturing apparatus and said image data.

The above-described object of the present invention can be fulfilled using an image capturing apparatus capable of communicating with other information processing apparatus and characterized in that said image capturing apparatus comprises a means for storing the individual unit identification information of the image capturing apparatus, and a means for transmitting said individual unit identification information to the image capturing apparatus.

The above-described object of the present invention can be fulfilled using an image capturing apparatus having removable memory media and characterized in that said capturing apparatus comprises a means for storing the individual unit identification information of the image capturing apparatus, a means for writing captured image information from the image capturing apparatus onto said memory media, and a means for transmitting said individual unit identification information to the image capturing apparatus.

The above-described object of the present invention can be fulfilled using a network-connected print service reception processing apparatus capable of communicating with an image capturing apparatus which contains image information, and characterized in that said print service reception processing apparatus comprises a means for reading stored image information from said image capturing apparatus, a means for reading the prestored individual unit identification information of the image capturing apparatus therefrom, and a means for transmitting said image information and said individual unit identification information via the network.

The above-described object of the present invention can be fulfilled using a network-connected print service reception processing apparatus having the removable memory media that contains image information, wherein said print service reception processing apparatus is characterized in that it comprises a means for reading said written image information from said memory media, a means for reading the prestored individual unit identification information of the image capturing apparatus from the memory media, and a means for transmitting said image information and said individual unit identification information via the network.

The above-described object of the present invention can be fulfilled using a network-connected print service administration apparatus characterized in that it comprises a means by which the individual unit identification information of each piece of image capturing apparatus, including the provider identification information and independent manufacturing information laid down in USB2.0 Standards, is received, a means by which image information is received, and a means for storing image information by logically linking said image information and said individual unit identification information.

The above-described object of the present invention can be fulfilled using a network-connected print processing apparatus characterized in that it comprises a means by which the individual unit identification information of each piece of image capturing apparatus, including the provider identification information and independent manufacturing information laid down in USB2.0 Standards, is received, a means by which image information that has been logically linked to said individual unit identification information is received, a first means by which images based on said image information are formed on recording media, and a second means by which said individual unit identification information or images equivalent thereto are formed on said recording media.

The above-described object of the present invention can be fulfilled using the memory media that can be mounted in and removed from an image capturing apparatus, wherein said memory media is characterized in that it contains the individual unit identification information of each piece of image capturing apparatus and image information which has been captured by said image capturing apparatus.

The above-described object of the present invention can be fulfilled using a print service method adopted for a system in which an image capturing apparatus for capturing and registering image data, a print service administration apparatus for administering the printing of the image data which has been recorded in said image capturing apparatus, a print service reception processing apparatus for uploading said image data into a center server, and a print processing apparatus for printing image data in accordance with instructions from said print service administration apparatus are connected via a network, wherein the print service method is characterized in that it comprises a process in which the image data that has been captured and registered by the image capturing apparatus and the individual unit identification information of each piece of image capturing apparatus are logically linked by said print service reception processing apparatus and then transmitted to the print service administration apparatus, a process in which the information that has been transmitted to the print service administration apparatus is stored, and a process in which, when said individual unit identification information is transmitted together with a print order to the print service administration apparatus, the image data corresponding to the individual unit identification information is transmitted to said print processing apparatus.

The above-described object of the present invention can be fulfilled using a print service method adopted for forming images based on the image information that has been recorded by an image capturing apparatus, wherein the print service method is characterized in that it comprises a process in which the prestored individual unit identification information of each piece of image capturing apparatus is read from said image capturing apparatus, a process in which the image information that has been stored into the image capturing apparatus is read, a process in which said image information is logically linked to said individual unit identification information, a process in which the foregoing linked image information is stored, a process in which the desired image information is selected from all stored image information, a process in which a print order for the foregoing selected image information is entered, a process in which order information that has been logically linked to said individual unit identification information is created from the foregoing entered print order, a process in which images are created on recording media from said image information and said order information, and a process in which said individual unit identification information or images equivalent thereto are printed on said recording media.

The above-described object of the present invention can be fulfilled using a print service reception processing method adopted for a network-connected print service reception processing apparatus capable of communicating with an image capturing apparatus into which image information has been stored, wherein the print service reception processing method is characterized in that it comprises a process in which the stored image information within said image capturing apparatus is read, a process in which the prestored individual unit identification information of each piece of image capturing apparatus is read from the image capturing apparatus, and a process in which the foregoing read image data and individual unit identification information are transmitted via the network.

The above-described object of the present invention can be fulfilled using a print service reception processing method adopted for a network-connected image information processing apparatus having the removable memory media that contains image information, wherein the print service reception processing method is characterized in that it comprises a process in which written image information is read from said memory media, a process in which the prestored individual unit identification information of each piece of image capturing apparatus is read from the memory media, and a process in which said image information and said individual unit identification information are transmitted via the network.

The above-described object of the present invention can be fulfilled using a print service administration method adopted for a network-connected print service administration apparatus and characterized in that it comprises a process in which the individual unit identification information of each piece of image capturing apparatus, including the provider identification information and independent manufacturing information laid down in USB2.0 Standards, is received, a process in which image information is received, and a process in which image information is logically linked to said individual unit identification information and stored.

The above-described object of the present invention can be fulfilled using a print processing method characterized in that it comprises a process in which the individual unit identification information of each piece of image capturing apparatus, including the provider identification information and independent manufacturing information laid down in USB2.0 Standards, is received, a process in which image information that has been logically linked to said individual unit identification information is received, a process in which images based on said image information are formed on recording media, and a process in which said individual unit identification information or images equivalent thereto are printed on said recording media.

### BRIEF DESCRIPTION OF THE DRAWINGS

FIG. 1 is a function block diagram showing the digital camera pertaining to an embodiment of the present invention.

FIG. 2 is a function block diagram showing the image data upload apparatus pertaining to an embodiment of the present invention.

FIG. 3 is an epitomic diagram showing the data structure of the CU codes pertaining to an embodiment of the present invention.

FIG. 4 is a function block diagram showing the center server apparatus pertaining to an embodiment of the present invention.

FIG. 5 is a function block diagram showing the lab server apparatus and lab printer pertaining to an embodiment of the present invention.

FIG. 6 is an epitomic view showing the print creation system pertaining to an embodiment of the present invention.

FIG. 7 is a flowchart showing the operation of the digital camera pertaining to an embodiment of the present invention.

FIG. 8 is a flowchart showing the main routine operation of the image data upload apparatus pertaining to an embodiment of the present invention.

FIG. 9 is a flowchart showing the operation of the center server apparatus pertaining to an embodiment of the present invention.

FIG. 10 is a flowchart showing the operation of the center server apparatus, lab printer, and center server apparatus pertaining to an embodiment of the present invention.

FIG. 11 is a flowchart showing the subroutine operation of the image data upload apparatus pertaining to an embodiment of the present invention, and the operation of the digital camera pertaining to the embodiment.

### DETAILED DESCRIPTION OF THE INVENTION

The present invention is described below using the figures that show the preferred modes of its embodiment.

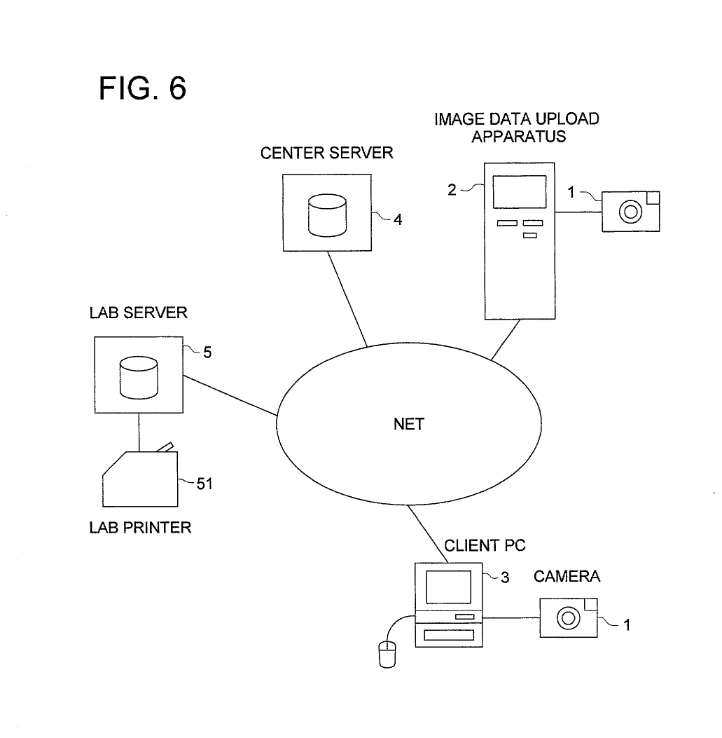

FIG. 6 is a diagram showing a network service system that includes the printing system pertaining to an embodiment of the present invention.

A customer terminal (client PC) 3, a print service reception processing apparatus (image data upload apparatus) 2, a center server 4, and a lab server 5 are connected to a wide area network (WAN) such as the Internet. In the lab, lab server 5 is connected to an image forming apparatus 51 via a LAN or the like. A digital camera 1 is connected to customer terminal (client PC) 3 or image data upload apparatus 2.

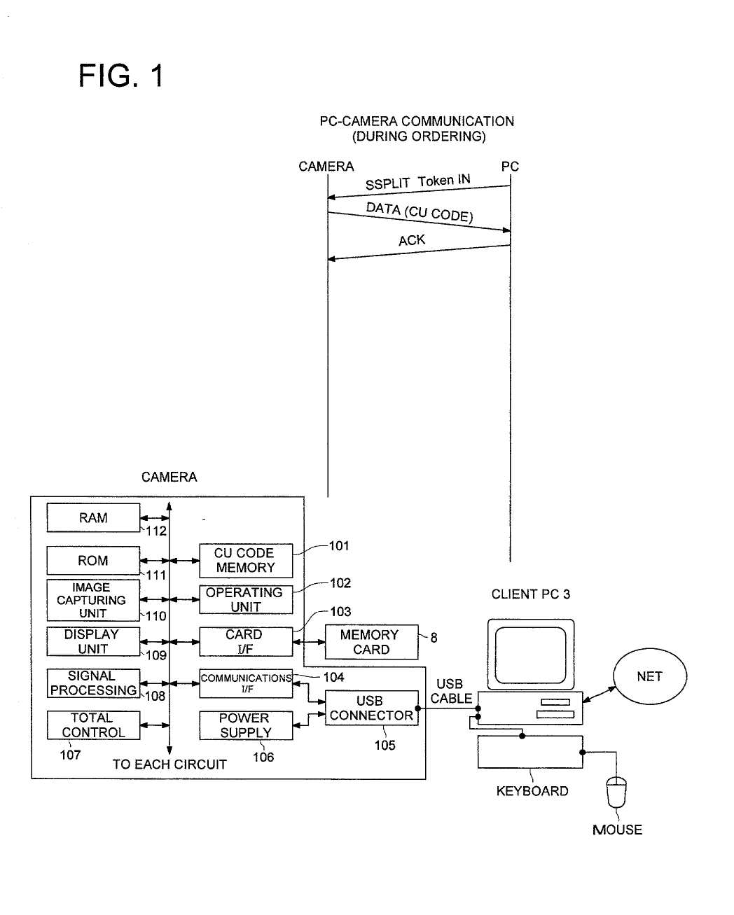

FIG. 1 is a function block diagram of the digital camera 1 pertaining to the image capturing apparatus in the present invention.

Digital camera 1 has a camera unique code memory (CU code memory) 101, an operating unit 102, a card interface (I/F) 103, a communications interface (I/F) 104, a USB connector 105, a power supply 106, a total control unit 107, a signal processing unit 108, a display unit 109, an image capturing unit 110, a ROM 111, and a RAM 112. A memory card 8 can be mounted in and removed from the digital camera. This configuration provides digital camera 1 with capabilities such as: converting into image data the images that have been captured by image capturing unit 110, then conducting signal processing with signal processing unit 108, storing processed image data onto memory card 8, reading stored image data from memory card 8, displaying the data on display unit 109, reading out stored image data and CU codes from memory card 8 and the CU code memory, and transferring the data and the CU codes to client PC 3 via the communications I/F.

Camera unique code memory (CU code memory) 101 functions as the individual unit identification information memory means in the present invention, and is a nonvolatile memory medium into which CU codes, that is to say, individual unit identification information, can be stored.

Operating unit 102 is a switch group, touchpanel, or the like that relates to digital camera operations, and comprises a power supply switch, a shutter button, a flash mode setting switch, an image capturing mode setting switch, an image capturing/playback mode setting switch, and the like.

Card I/F 103 equivalent to the image information memory means and identification information memory means in the present invention is an interface that enables image data to be written onto/read out from memory card 8 which can be mounted in and removed from digital camera 1.

Memory card 8, a memory medium that can be mounted in and removed from digital camera 1, is a memory for storage of image data, CU codes, and various other accompanying data, and in the present embodiment, the memory card is constructed as a flash memory represented by a compact flash memory, SmartMedia, SD card, or stick memory.

The information transmitting means and information receiving means in the present invention are interfaces compliant with generally known standards, intended for communication with client PC 3. These interfaces can be, for example, RS-232C, EEE1394, USB, IrDA, or Bluetooth interfaces.

In the present embodiment, a USB connector 105 compliant with USB standards is used as an information transmitting means, an information receiving means, and a power receiving means. In addition to a signal line leading to communications I/F 104, a power supply line is connected to power supply 106, from which power is supplied to various circuits, including at least those of communications I/F 104 and total control unit 107. Thus, even when digital camera 1 is powered off, supply of power from client PC 3 or image data upload unit 2 enables CU codes to be transferred to client PC 3 or image data upload unit 2.

Total control unit 107, the control means in the present invention, performs various control functions based on the internal control programs of ROM 111. These functions include the process of reading in captured image signals from signal processing unit 108 and transferring these signals to RAM 112, the process of transferring data from RAM 112 to display unit 109, the process of transferring image data to card I/F 103 in a file format, and the process of transferring stored CU codes from CU code memory 101 to the communications I/F.

Signal processing unit 108 performs analog/digital (A/D) conversions between output electrical signals, followed by various image processing operations such as the gamma correction, color space conversion, and white balance adjustment of digitized signals.

Image capturing unit 110 comprises lenses, photoelectric conversion elements, a strobe (not shown in the figure), and more. The photoelectric conversion elements, such as CCD, convert into electrical signals the images that have been projected by the lenses, and the strobe emits light in response to instructions from the total control unit.

Display unit 109, the display means in the present invention, can use liquid crystal display elements, a plasma display, or a CRT. In addition to images, text, input images from the image capturing unit, and menus for setting various conditions, the display unit displays the CU codes stored within CU code memory 101, and more.

ROM 111 contains control programs designed for the total control unit to perform various control functions on digital camera 1.

RAM 112 is used for storing the captured image data that has been transferred from signal processing unit 108, for providing such image data with specified image processing, for temporarily storing the compressed image data that has been read out from memory card 8, and for temporarily saving various data. The RAM is also used as a work area for image compression and decompression.

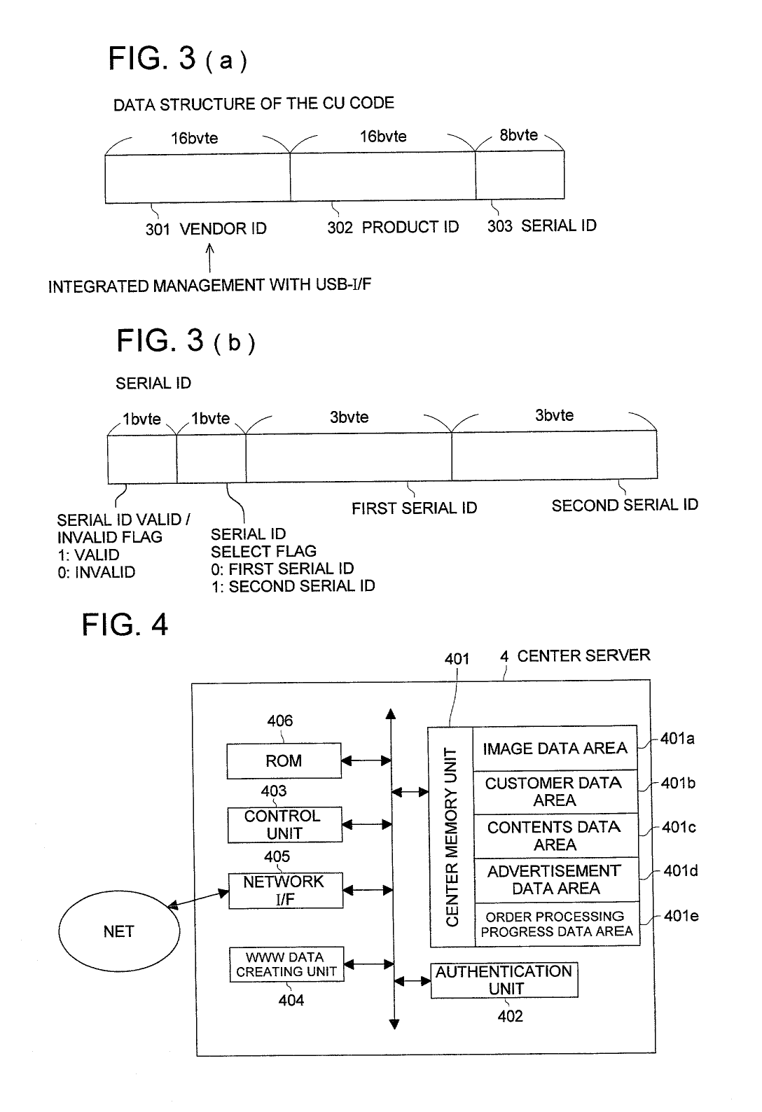

FIG. 3 (a) shows an example of the structure of the camera unique code stored within CU code memory 101.

The camera unique code consists of a vendor ID (provider identification information), a product ID, and a serial number (independent manufacturing information). This code contains the information defined in Section 9.6, “Standard USB Descriptor Definitions”, of Universal Serial Bus Specification Revision 2.0 (Apr. 27, 2000) [hereinafter, referred to simply as USB2.0].

Vendor ID 301 is a 16-byte code identifying the supplier of digital camera 1. Vendor IDs can be the IDs that are standardized per the USB2.0 standards and managed in integrated form by the USB Implementers Forum.

Product ID 302 is a 16-byte code identifying the product name of digital camera 1. Under USB2.0, product IDs are to be managed by the digital camera manufacturers on their own.

Serial ID303 is an eight-byte code that identifies digital camera 1. Under USB2.0, serial IDs can be managed by the digital camera manufacturers on their own. Usually, a manufacturing number consisting of the place of manufacturer and a serial number is used as the serial ID. However, more than one serial number can also be stored by assigning a one-byte sub-number to each serial number beforehand. That is to say, a first CU code and a second CU code have been stored in CU code memory 101 beforehand and the user can be select either the first CU code or the second CU code by changing the serial ID selection flag. Operating unit 102 that performs serial number changing operations at this time functions as an identification information selection means. Thus, even if the ownership of the digital camera is transferred to another person, the new owner can receive print services without confusion. The number of serial IDs stored beforehand can also be three or more.

Also, operations from operating unit 102 enable total control unit 107 to freely regulate the transmission of CU codes to other information processing apparatus and storage of the CU codes onto memory media. For example, if no CU codes are to be used, all CU codes can be made invalid by setting up a serial ID invalid flag at the position of the serial ID valid flag. In this case, print services can, of course, be received, irrespective of whether the corresponding person is the owner or user of digital camera 1. Operating unit 102 that performs operations relating to the regulation of CU code transmission and storage at this time functions as a transmission state selection means or storage state selection means. Digital camera 1 can have a means for communicating with a mobile communications network represented by the cellular phone, and in that case, the individual unit identification code assigned to the cellular phone during its manufacture can be used, instead of a CU code, and the above-mentioned means for communicating with a mobile communications network can replace the USB connector 105 functioning as the information transmitting means and receiving means in the system.

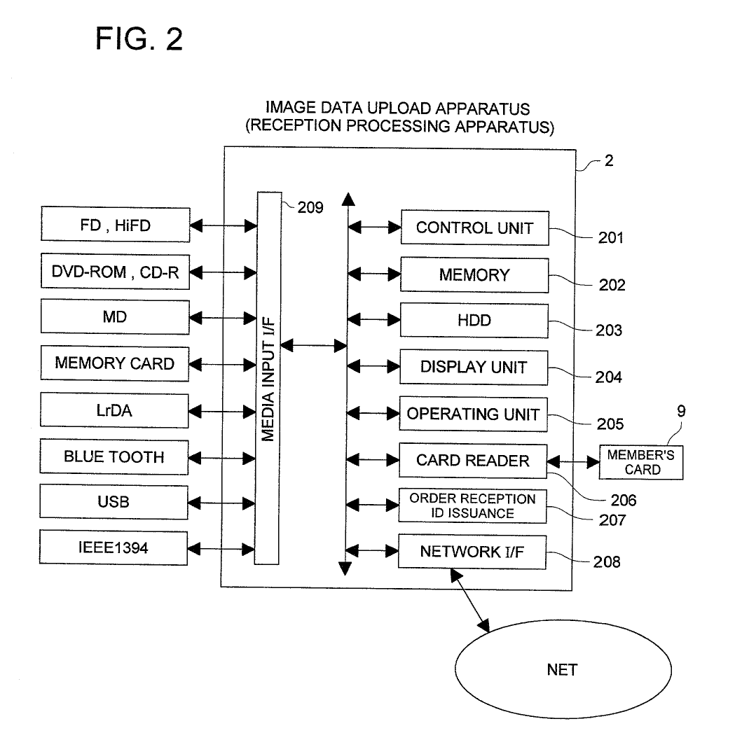

FIG. 2 is a function block diagram of the image data upload apparatus 2 pertaining to the print service reception processing apparatus in the present invention. In this figure, print orders undergo reception processing.

Image upload apparatus 2 comprises a control unit 201, a memory 202, a hard disk drive (HDD) 203, a display unit 204, an operating unit 205, an input interface (I/F) 209, a network interface (I/F) 208, an order reception ID issuing unit 207, and a card reader 206.

Input I/F 209, which functions as the image information reading means and identification information reading means in the present invention, has a plurality of memory media accommodation holes or connectors and memory media reading features so that the various types of memory media in which the image information corresponding to the images that have been captured by digital camera 1 is stored can be freely accommodated. These memory media reading features can be, for example: a magnetic disk drive such as an FD drive or HiFD drive; an optical disk drive such as an MD drive, CD-R, CD-RW, or DVD drive; the card interfaces that correspond to memory cards, including SmartMedia (SSFDC), a compact flash memory, a memory stick, and an SD card; cable connection interfaces, including USB or IEEE1394 interfaces; wireless interfaces, including a Bluetooth interface; and/or the like. Also, TIFF, GIF, JPEG, FlashPix, Exif, and the like are provided as the formats of digital images.

Network I/F 208, which functions as the information transmitting means and information receiving means in the present invention, is a communications I/F for exchanging data with other information processing apparatus, and this I/F is connected to a wide area network (WAN) such as the Internet, by use of a generally known method.

Control unit 201 provides total control of image data upload apparatus 2 in accordance with the control programs stored within memory 202 or HDD 203. Total control of image data upload apparatus 2 includes, for example, the process of reading in image information that has been received from media input interface (I/F) 209 and transferring the information to HDD 203, the process of transferring data from HDD 203 to display unit 204, and the process of logically linking input image information and a CU code or of logically linking a CU code and the input order from operating unit 205 and processing the linked order into order data.

Hard disk drive (HDD) 203 stores application programs executable by control unit 201 and temporarily stores the image data and order data that have been received from media input I/F 209.

Display unit 204 consists of liquid crystal display elements and a CRT display. The display unit displays image information that has been transferred from HDD 203, and displays the orders and personal information that have been received from operating unit 205.

Operating unit 205 equivalent to the image selection input means and order input means in the present invention comprises a keyboard, a touchpanel, a joystick controller, and other elements. The operating unit is used for entering orders and personal information.

Card reader 206 has a magnetic recorder/reader, an optical reader, and an IC card reader, and reads member information that has been registered in memory card 9 beforehand.

Order reception ID issuing unit 207 issues order reception IDs as the identification information to be used to logically link image data, orders, and personal information, on an order-by-order basis after the image data has been received from media input I/F 209.

FIG. 4 is a function block diagram showing the center server pertaining to the print service administration apparatus in the present invention.

In addition to a center memory unit 401, in which an image data area 401a, a customer data area 401b, a contents area 401c, an advertisement data area 401d, and an order processing progress data area 401e are provided, center server 4 comprises an authentication unit 402, a control unit 403, a World-Wide Web (WWW) data creating unit 404, a network interface 405, and a ROM 406, and functions as a so-called “WWW” server.

In image data area 401a that is the image information memory means in the present invention, image data that has been received from image data upload apparatus 2 is stored in the file format that the image data has been logically linked to CU codes.

In customer data area 401b that is the personal information memory means in the present invention, personal information, such as the names, addresses, telephone numbers, and order histories of customers, that has been entered from image data upload apparatus 2 or client PC 3 and then received via the network is stored in the file format where in the file format that the personal information has been logically linked to CU codes or other identification codes.

In contents area 401c, template images, various types of text, shop information, and other information supplied through WWW are stored in file formats.

In advertisement data area 401d that is the advertisement information memory means in the present invention, advertisement image data and advertisement text data that have been supplied from advertisement clients are stored with logical linkage to the vendor IDs which are included in CU codes.

In order processing progress data area 401e that is the print order processing progress information memory means in the present invention, the progress of print order processing based on order data which has been received from customers is coded, then logically linked to CU codes, and stored.

Authentication unit 402 that is the comparison means and access restriction means in the present invention performs comparisons between the CU codes or other identification codes that have been transmitted from information processing terminals, including client PC 3, via the network, and the information stored within customer data area 401b, and then acknowledges or rejects access to various data that has been stored into center memory unit 401 via other information processing terminals.

Control unit 403 provides total control of center server 4 in accordance with the control programs stored within ROM 406. Total control of the center server includes, for example, the process of transferring to image data area 401a the image information that has been received from network I/F 405, the process of transferring image data from image data area 401a to lab server 5 via network I/F 405 and the network, the process where the information contained in order processing progress data area 401e is updated in accordance with received order processing progress information, the process of transmitting received order data to lab server 5 via network I/F 405 and the network, and the process of logically linking a CU code and the input order from operating unit 205 and processing the linked order into order data.

WWW data creating unit 404 that is the display-use image information creating means in the present invention creates WWW-matching data based on various information which has been stored into center memory unit 401.

Network I/F 405 that functions as the image information receiving means, access ID receiving means, display-use image information transmitting means, display-use advertisement information transmitting means, personal information receiving means, print order receiving means, and print order processing status transmitting means in the present invention, receives various data via the network and transmits WWW data that has been created by WWW data creating unit 404, order data that has been created by control unit 406, and image data that has been stored into image data area 401a.

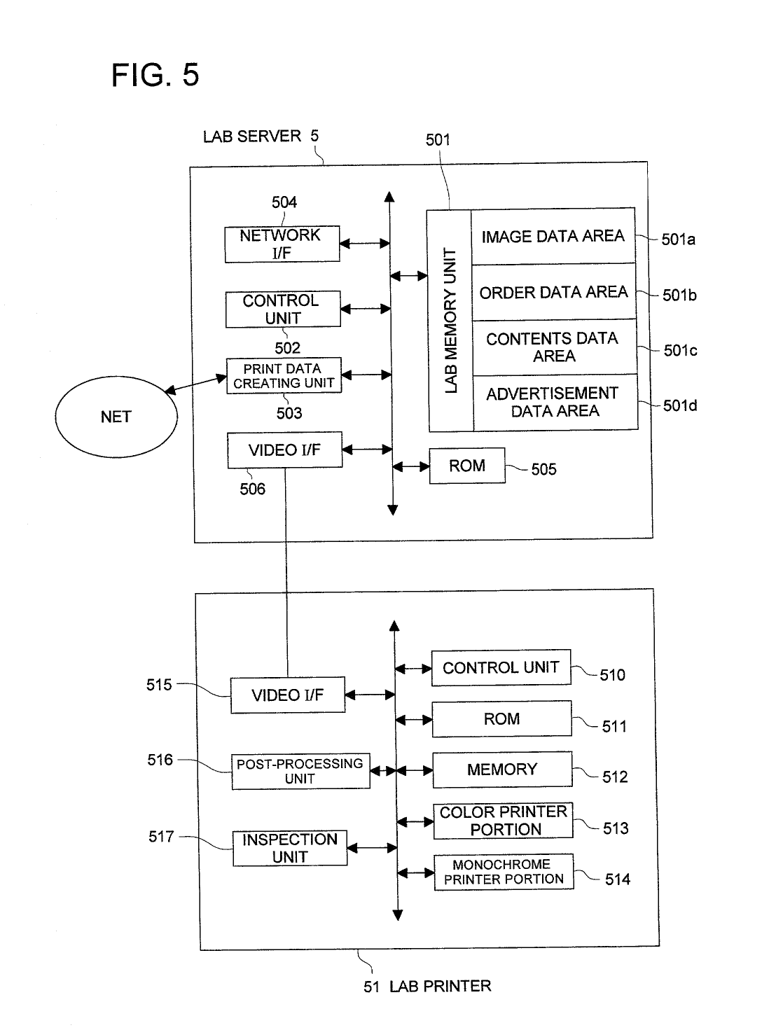

FIG. 5 is a function block diagram of the lab server 5 and lab printer 51 pertaining to the print processing apparatus in the present invention. In addition to a lab memory unit 501 in which an image data area 501a, an order data area 501b, a contents area 501c, and an advertisement data area 501d are contained, lab server 5 is equipped with a control unit 502, a print data creating unit 503, a network I/F 504, a ROM 505, and a video interface (I/F) 506, and has printer server functions for so-called “image processing” and lab printer 51. Lab printer 51 is equipped with a control unit 510, a ROM 511, a memory 512, a color printer portion 513, a monochrome printer portion 514, a video I/F 515, a post-processing unit 516, and an inspection unit 517, and has printer functions.

In image data area 501a, image data that has been transferred from the center server is stored in the file format that the image data has been logically linked to CU codes.

In order data area 501b, order data that has been transferred from the center server is stored in the file format that the order data has been logically linked to CU codes or order receiving IDs.

In contents area 501c, the template images, delivery forms, and other images that have been supplied as print-out from the lab printer after they have been combined with the image data stored within image data area 501a are stored in a file format.

In advertisement data area 401d that is the advertisement information memory means in the present invention, advertisement image data that has been supplied from advertisement clients are stored with logical linkage to the vendor IDs which are included in CU codes.

Control unit 502 provides total control of lab server 5 in accordance with the control programs stored within ROM 505. Total control of the lab server includes, for example, the process of transferring image data to print data creating unit 503 after the image data has been received from network I/F 504, the process of transferring video signals from print data creating unit 503 to lab printer 51 via video I/F 506, the process of transmitting order processing progress information to center server 4 via network I/F 504, and the process of transmitting the control signals for lab printer 51 via video I/F 506.

Print data creating unit 503 provides various types of generally known image processing based on image information and other information, and creates the print data (video signals) matching to lab printer 51.

Network I/F 504 receives various data via the network and transmits order processing progress information to center server 4.

Video I/F 506 transmits to lab printer 51 the print data that has been created by print data creating unit 503, and receives control signals from the lab printer.

Control unit 510 of lab printer 51 controls the lab printer, subject to the stored control programs within ROM 511. Control of the lab printer includes, for example, the process of transferring to color printer portion 513 or monochrome printer portion 514 the print data that has been entered via video I/F 515, the process of controlling post-processing unit 516 in accordance with the information that has been detected by inspection unit 517, the process of controlling color printer portion 513 or monochrome printer portion 514 in accordance with the control commands that have been transmitted from lab server 51, and the process of transmitting control commands to the lab server via video I/F 515.

Memory 512 temporarily stores print data that has been transferred via video I/F 515.

Color printer portion 513 that is the first image forming means in the present invention is a printer by which the images that have been captured by digital camera 1 are formed as color images on recording paper, subject to print data that has been transferred from lab server 5 via video I/F 515.

Monochrome printer portion 514 that is the second image forming means in the present invention is a printer by which the CU codes or other identification codes that have been logically linked to said image data, or the characters or graphics corresponding to the CU codes or other identification codes is formed in monochrome on the reverse side of said recording paper or the unrecorded portions of said color images, subject to print data that has been transferred from lab server 5 via video I/F 515. The above-mentioned CU codes or other identification codes are formed as images in character or bar code form.

The image forming methods adopted for color printer portion 513 and monochrome printer portion 514 can be either silver-salt photography, electronic photography, the ink jet scheme, or the thermal scheme.

Inspection unit 517 that is the individual unit identification information detection means in the present invention reads via an optical sensor or the like the CU codes or other identification codes formed on recording paper, and inspects whether the print order and the printer output of images from lab printer 51 are logically linked.

Post-processing unit 516 that is the recording media processing means in the present invention sorts and rearranges image-containing recording paper under the control of control unit 510, and bundles and packages the recording paper for each print order. The apparatus described in, for example, Unexamined Japanese Patent Application Specification No. 2000-77893 can be used as the post-processing unit.

The lab server 5, center server 4, and lab printer 51 described above are functionally separated. Physically, however, these components can also be integrated into one place or one unit.

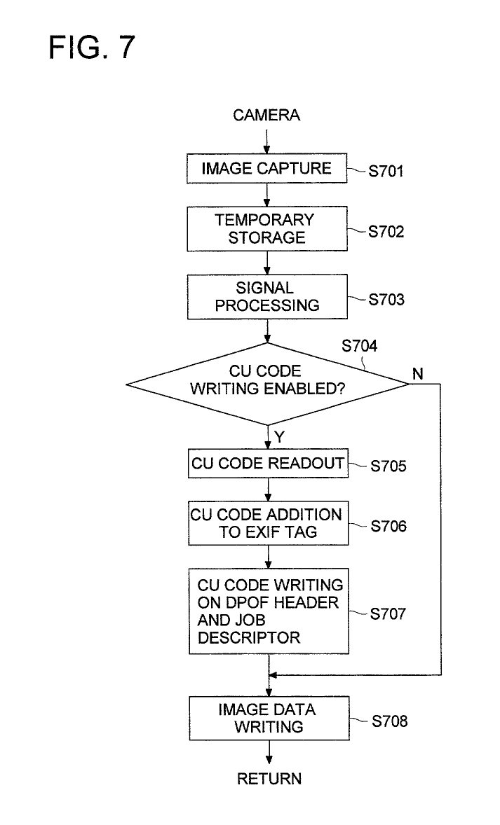

The operation of the digital camera pertaining to an embodiment of the present invention is described below using FIG. 7.

When the release button on digital camera 1 is pressed, control of the light exposure level, control of the flash light intensity, control of focus, confirmation of the memory card recording capacity, and other processes are performed by control unit 107 and then images are captured (S701). Captured images are converted into digital signals by image capturing unit 110, then these signals are temporarily stored into RAM 112 (S702), and white level balance adjustment, level control, and other signal processing operations are performed by signal processing unit 108 (S703).

The confirmation of whether the writing of CU codes has been regulated is accomplished beforehand (S704) by the CU code write enabling operations of operating unit 102, and when CU code writing is enabled, CU codes are read out from CU code memory 101 (S705) and CU codes are added to the Exif tag for the temporarily stored image data (S706). Under the Exif2.1 standards, only vendor IDs and product IDs among all CU codes can use an Exif tag “Make” area and a “Model” area, respectively, and thus serial IDs are to reserve their own area. The Exif tag is described in detail in Section 2.6, “Tags”, of “Digital Still Camera Image File Format Standard (Exchangeable image file format for Digital Still Camera: Exif) Version” (2.1JEIDA-49-1998), one of the Japan Electronic Industry Development Association Standards.

After the above, DPOF data with added CU data is written onto memory card 8 via card I/F 103 (S707). At this time, under DPOF1.0 standards, a vendor ID and a product ID can be added to the “Camera model name” at the header (HDR) part, and thus a serial ID is to be added to “Vendor Unique” at the job descriptor part. Details of DPOF are described in the reference document relating to DPOF Version 1.10 (http://www.panasonic.co.jp/avc/video/dpof/dpof_{—}110/white. htm), announced jointly by four DPOF proposer companies: Canon Inc., Eastman Kodak Co., Fuji Photo Film Co., Ltd., and Matsushita Electric Industrial Co., Ltd.

During S704 if CU code writing is prohibited, or after S707, image capturing/processing by digital camera 1 is completed with image data writing into the recording area of memory card 8 (S708).

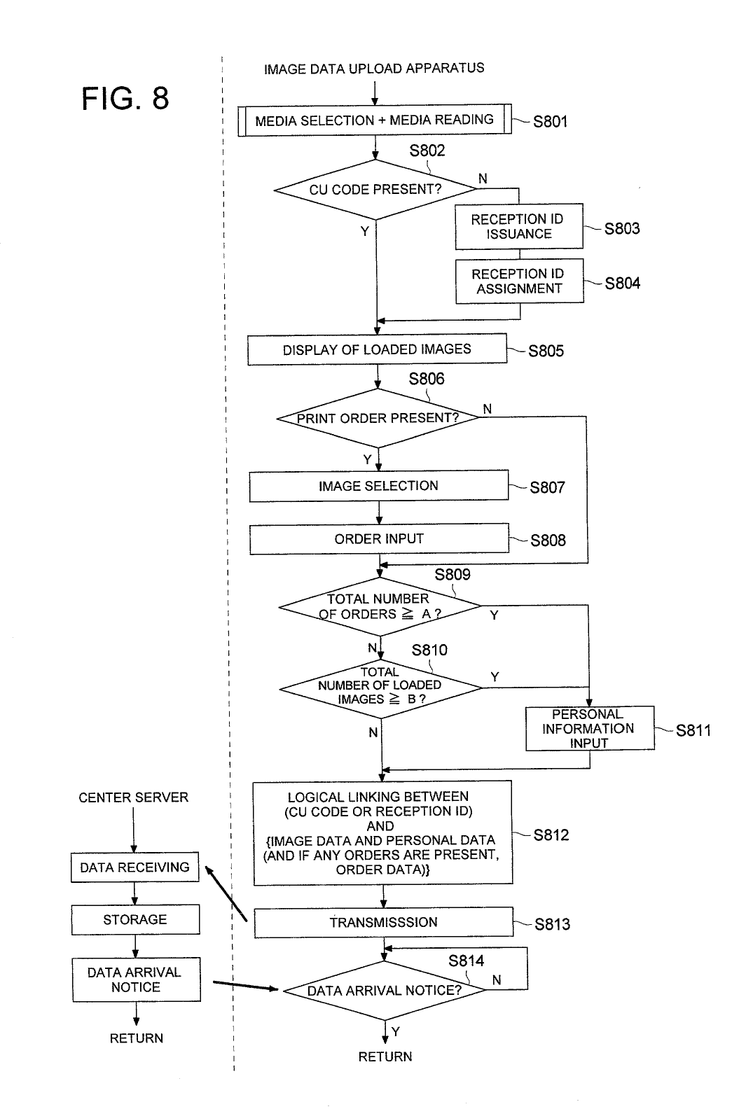

The operation of the image data upload apparatus 2 pertaining to the present embodiment is described below seeing FIG. 8. The image data upload apparatus 2 pertaining to the present embodiment is installed in a print order processing agent or a convenience store (hereinafter, these sites are referred to collectively and simply as the agent).

A customer wishing to print images takes with him or her to the agent either the memory card 8 or removable media or his or her digital camera 1 on which is recorded the image data corresponding to the images which were captured using the digital camera.

When image data uploading is specified from the image data upload apparatus having its initial display window appearing on the screen, the window for requesting the selection of an image data input method will be displayed. In the present embodiment, the user is to select whether removable media is to be inserted into the digital camera of the present invention or data is to be transferred from the digital camera of the invention (this operation is referred to as media selection). After the above selection, data loading (media reading) from the removable media or the digital camera will be started (S801).

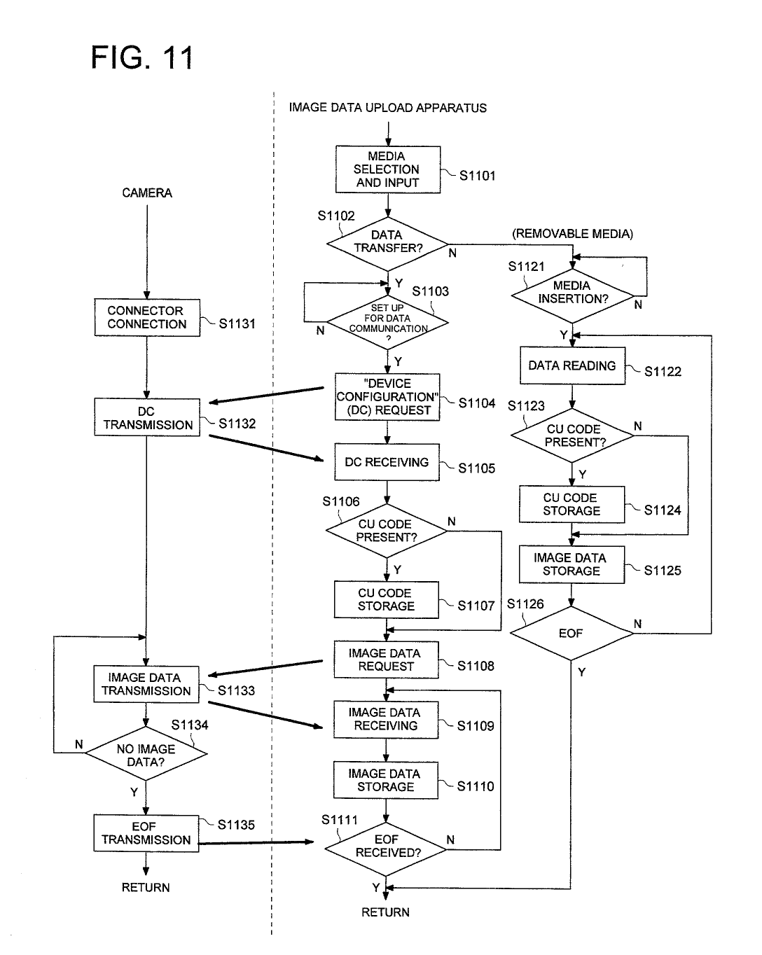

The media selection and media reading in S801 are described below seeing FIG. 11.

The user selects and enters the type of media (S1101).

If data transfer from the digital camera is selected in S1102 (in the present embodiment, description is given using USB as an example), USB connector 105 on digital camera 1 is to be connected to the media input I/F 209 of image data upload apparatus 2 (S1131). The radio communications unit, if provided, is then to be started.

When connection to the digital camera is detected by a sensor and the image data upload apparatus is set up for data communication (S1103), the image data upload apparatus will start the setup transaction for transmitting to digital camera 1 the control signal laid down by the relevant standards, and request the digital camera to transmit device configuration information (S1104). Digital camera 1 will execute the IN transaction for transmitting the signal corresponding to the control signal, and transmit the device configuration information for identifying the equipment characteristics of digital camera 1 (S1132). The device configuration information includes a CU code as the individual unit identification information used in the present invention. The transmitted device configuration information including a CU code will be received (S1105). At this time, since a CU code may not be included, the confirmation of whether it is included in the device configuration information will occur (S1106), and if a CU code is included, the CU code will be temporarily stored into memory 202 (S1107). If a CU code is included, processing will advance intact to S1108.

After this, a request for transmitting the image data that has been written onto memory card 9 of digital camera 1 will be issued from image data upload apparatus 2 to digital camera 1 (S1108). In response to this request, digital camera 1 will transmit the image data (S1133) and the image data thus received (S1109) will be temporarily stored onto HDD 203 (S1110). Hereafter, steps S1133 and S1134 will be repeated until all image data written onto memory card 8 is transmitted, and in S1134, when the transmission of all image data is completed, digital camera 1 will transmit an end-of-file (EOF) signal to image data upload apparatus 2 (S1135) and hereby, operation will be completed. Image data upload apparatus 2 that has received the EOF signal will terminate the media reading process and return to the main routine (S1111).

Conversely, if the insertion of the removable media is selected in S1101, the image data upload apparatus will wait for the removable media to be inserted into the opening in the upload apparatus (S1121), and then when the fact that the removable media has been fixed to a position in which the image data can be read is detected by a sensor, media input I/F 209 will read the data recorded on the removable media (S1122). At this time, the confirmation of whether a CU code is included will occur (S1123), and if a CU code is included, the CU code will be temporarily stored into memory 202 (S1124). If a CU code is included, processing will advance intact to S1125. And temporary storage of the remaining image data onto HDD 203 will be repeated (S1125), and when the reading of all image data is completed, the image data upload apparatus will terminate the media reading process and return to the main routine (S1126).

After the image data upload apparatus has returned to the main routine, judgment of whether a CU code is included in the data which was read in S801 will occur (S802). Since the presence or absence of a CU code was also judged in S1106 or S1123, the use of the judgment results naturally enables the omission of still another similar judgment in step S802. And if a CU code is not included, the ID issuing means will issue a unique order reception ID on its own (S803) and the corresponding image data will be supplied to the user as, for example, the IC card containing the reception ID, print-out of the reception ID on the required paper, screen display of the reception ID on display unit 204, or transfer of the reception ID to a cellular phone (S804).

All the images corresponding to the image data which was read in S801 will be displayed in index form on the screen of display unit 204 (S805). If full-size image data and thumbnail image data whose volume is smaller than that of the full-size image data are recorded for one image within the removable media or digital camera, images based on the thumbnail image data will be displayed in index form. If image data smaller in the volume of data is not stored, it will be possible for image data smaller in the volume of data to be created from the full-size image data that has been read out, and then to be displayed in index form.

At this phase, the user judges whether a print order is to be placed, and enters the results (S806). The user can only register image data at this phase and later, actually place a print order. This method is convenient when the user, for example, first only uploads image data such as a group photograph, then releases the image data to the public, and raise purchasers before placing a batch order.

To place a print order at this phase, the user selects the desired image(s) from all displayed images (S807) and places the print order (S808). Detailed order information, more specifically, information on the receiving of finished prints, even more specifically, specifying the type of service (normal printing or postcard printing), further specifying the type of postcard in the case of postcard printing, and specifying the type/quality of printing paper, the print size, the number of prints, the width of edge margins, whether to give gloss, and other factors, is entered from operating unit 205, and entered information is temporarily stored as order data into memory 202.

In addition to the above, the type of image processing with which the image data is to be provided is specified. The type of image processing that can be specified is, for example, black and white finishing, sepia tone finishing, red-eye compensation finishing, or trimming.

In order to prevent the occurrence of tampering acts such as uploading a great volume of images whose printing originally is not to be ordered from the beginning, if the number of prints that was ordered in S809 is greater than a predetermined value or if the volume of image data which was read in S810 is greater than a predetermined value, input of the user's personal information will be requested (S811). The necessary input items in this case will be the name, address, telephone number, etc. of the user. The personal information that has thus been entered will be temporarily stored into memory 202.

Image data that has been temporarily stored onto HDD 203 is logically linked to the required CU code, or if a CU code is not present, the image data will be logically linked to the issued reception ID (S812). If personal information and order data have been entered from operating unit 205, the information and the data will also be linked together and transmitted to center server 3 via the Internet (S813).

More specifically, logical linkage can be established by, for example, using the CU code as the file name of the image data or order data or using the CU code as the directory name where the image data or the order data is contained, or separately creating a table format file that represents the relationship between the file name and the CU code and transmitting this table format file together with the personal information and the order data.

If the CU code alone is used as the file name (of, for example, the “CU code.jpg” format) or the directory name, only one image or directory can be linked to that CU code. Using the CU code as the file name of the image data or order data, therefore, refers to using the CU code in such a manner that it can be linked to a plurality of unique files, and examples of such a usage format include “CU code+Image capturing time.jpg”, “CU code+Reception time.prg”, “CU code+Serial order number”, etc. It is desirable that a value or numeric value enabling the name to be changed to a unique name by adding the CU code should be added.

Order information that has thus been linked is structured in the format conforming to the DPOF standards described above.

When data transfer is completed, the center server having a communications capability will transmit a data arrival notice via the Internet to notify to the image data upload apparatus 2 of the agent that the data has been transferred, and the image data upload apparatus 2, after receiving the data arrival notice, will, in S814, eject the removable media or close the communication with the digital camera and activate display unit 204 to display a message indicating that the transfer of the image data has been completed.

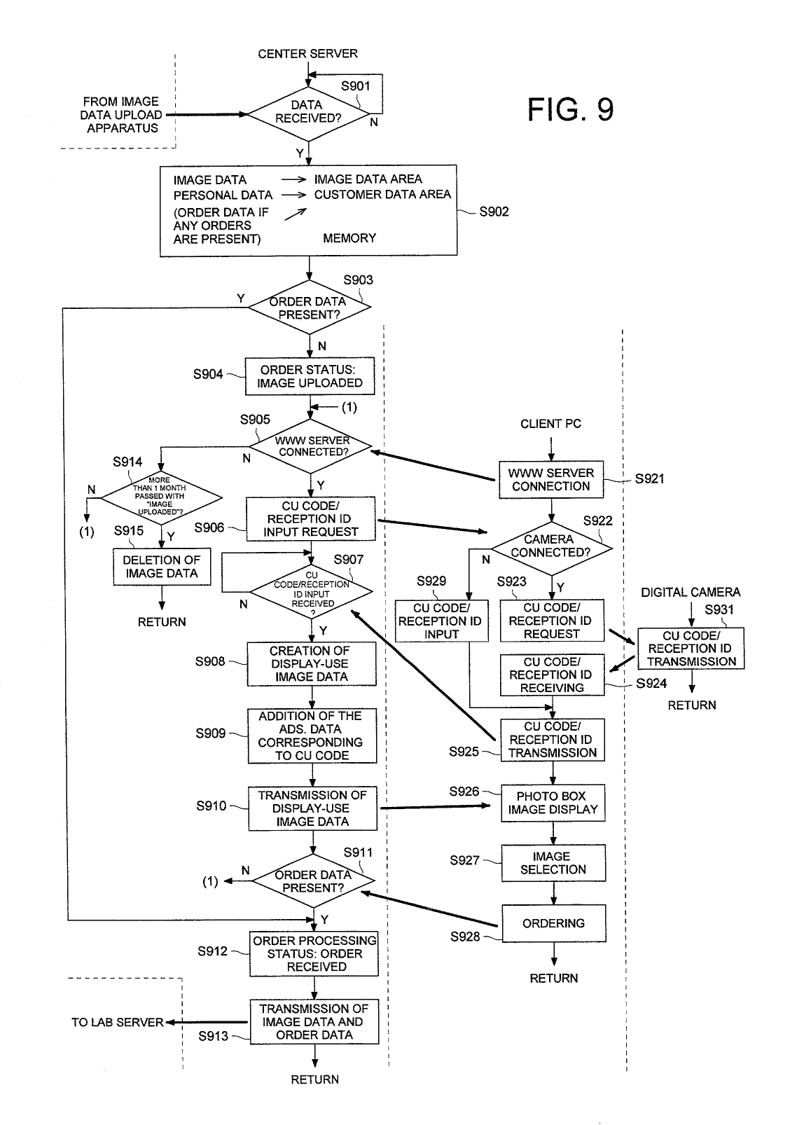

The operation of the center server and client PC pertaining to the present embodiment is described below seeing FIG. 9.

When data is transmitted from image data upload apparatus 2 (S901), the transmitted CU code (or reception ID) and the image data, personal information, and order data that have been linked to the CU code (or reception ID) will be stored into center memory unit 401 (S902).

After this, whether a print order has been placed using image data upload apparatus 2, that is to say, whether order data has been transmitted from image data upload apparatus 2 is judged (S903) and if no order data has been transmitted, order processing progress information that has been automatically created in CU code linked form in order processing progress data area 401e in synchronization with the storage of the image data will be displayed as “Image Uploaded” (S904) and processing will shift to a waiting status for connection from the user (S905). If the user did not place a print order in S806 above, he or she can place a print order in step S905. If the order has already been placed, that is to say, if order data has been transmitted, processing will advance to S912.

When placing a print order from client PC 3 via the Internet, the user accesses the center server of a predetermined universal resource locator (URL) from client PC 3 via the Internet by use of a web browser or the like (S921) and enters a CU code or a reception ID.

Although a CU code or a reception ID can be entered from the keyboard (S929), automatic entry is also possible by connecting either the digital camera 1 of the present invention or the removable memory card of the digital camera of the invention to client PC 3.

When digital camera 1 of the invention is connected (S922), the plug-in application program prestored within the memory means of client PC 3 will be started up and communication with digital camera 1 will be started.

Connection to digital camera 1 will be detected by a sensor, client PC 3 will, in S923, execute the setup transaction for transmitting to digital camera 1 the control signal laid down by the relevant standards, and digital camera 1 will, in S931, execute the IN transaction for transmitting the signal corresponding to the control signal. The signal transmitted during the execution of the IN transaction will include the device configuration information for identifying the equipment characteristics of digital camera 1, and the device configuration information will further include a CU code as the individual unit identification information used in the present invention. The transmitted CU code will be received at client PC 3 and temporarily stored into memory (S924).

At this time, the power of digital camera 1 does not need to be on. The above-described transaction will be executed using only the power supplied from client PC 3 via the USB connector. Similar operation can also occur when a connection means conforming to the IEEE1394 standards is provided.

When the memory card that can be mounted in and removed from digital camera 1 is connected to client PC 3 (such connection is not shown in the figure), the fact that the memory card has been inserted into the card reader will be detected by a sensor and the plug-in application program prestored within the memory means of client PC 3 will be activated to transmit a reading permission signal. In response to this reading permission signal, the card reader will read out the CU code recorded on the memory card and temporarily store the CU code into memory.

If digital camera 1 does not use a CU code, the reception ID that was stored during S803 can be read out from the memory card.

As with the CU code or reception ID that has been entered from the keyboard, the CU code or reception ID that was temporarily stored into memory will be transmitted to the center server (S925).

After receiving the CU code or the reception ID (S907), center server 4 will search for the image data corresponding to the received CU code or reception ID, from all image data stored in image data area 401a, and create display-use image data from the detected image data (S908). The display-use image data consists of hypertext, a markup language (HTML), and an image file that has been linked to HTML; the image file reducing the resolution and image size of the original image data stored within image data area 401a, and having been converted into a format convenient for display on the display screen of client PC 3.

Also, the vendor ID included in the CU code will be extracted, then the advertisement image data and advertisement text data corresponding to the vendor ID will be read out from advertisement data area 401d, and advertisement data will be added to the display-use image data (S909). After this, the display-use image data with the added advertisement data will be transmitted to client PC 3 (S910) and the images corresponding to the transmitted CU code will be displayed on the display unit of client PC 3 (S926).

The user selects the desired image from all displayed images (S927) and places a print order (S928) Detailed order information is entered similarly to placing a print order from image data upload apparatus 2.

When order data is received from client PC 3, as is the case with order data receiving from image data upload apparatus 2, order processing status information will be changed to “Order Received” (S912), then the image data and order data pertaining to the order will be linked to the CU code or the reception ID, and both data will be transmitted to lab server 5 (S913) to return image data upload apparatus 2 to its stand-by status.

If printing is not ordered and image data only remains uploaded, the image data will be deleted for a fixed term (for example, one month) after being stored into center server 4. More specifically, if no access is made from client PC 3 to center server 4, whether more than one month has passed with the order processing status information remaining changed to “Image Uploaded” will be judged (S914) and then if more than one month has already passed, the corresponding image data will be deleted from image data area 401a (S915).

It is desirable that since, even when printing is later requested from the user, the image data upload procedure laid down above does not need to be taken again, the image data for which a print order has been placed should be saved in center server 4 for a term (for example, one year) based on the corresponding contract conditions.

Although, in the present embodiment, center server 4 is used as the storage location for the image data which is to be used for printing, the memory area within center server 4 can also be used as a WWW server only, in which case, the image data to be used for printing is stored into lab memory unit 501 of lab server 5.

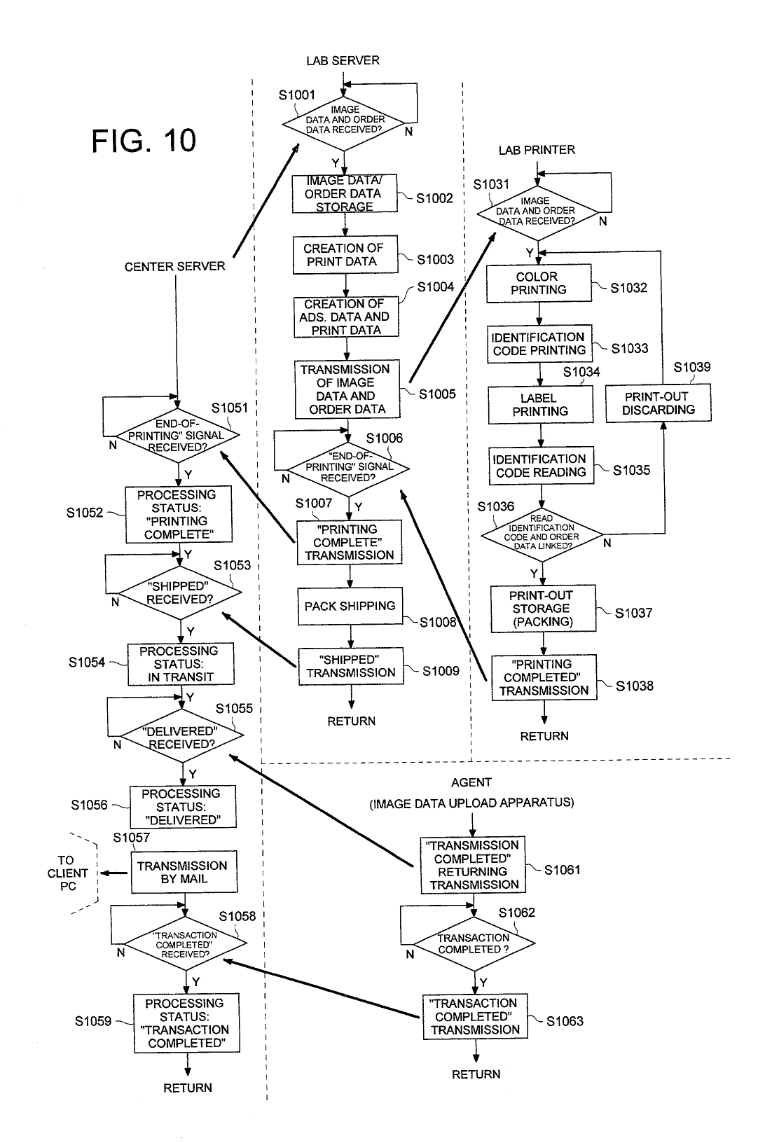

The operation of the lab server 5 and lab printer 51 in the lab is described below using FIG. 10.

When the image data and order data that have been transmitted from center server 4 are received (S1001), both types of data will be linked to a CU code or a reception ID and then sequentially stored into the image data area 501a and order data area 501b of lab memory unit 501 (S1002).

Print data will be created (S1003) by print data creating unit 503 in the order that the order data has been received. During the creation of the print data, generally known data development and signal processing based on the image data and order data corresponding to the CU code will be executed. If a template is specified for the order data, the particular data and the template image(s) stored within contents area 501c will be synthesized using a known method.

Furthermore, the vendor ID included in the CU code will be extracted, then the advertisement image data corresponding to the vendor ID will be read out from advertisement data area 501d, and print data will be created from the advertisement image data (S1004).

Created print data will be transmitted together with order data to lab printer 51 via the network (S1005). When the print data is received (S1031), lab printer 51 will activate color printer portion 513 so that images based on the print data will be formed (printed) on recording paper (S1032), and also activate monochrome printer portion 514 so that images of the graphics (for example, bar codes) corresponding to the identification code (CU code or reception ID) will be formed on the reverse side of recording paper or outside the recording area thereof (S1033).

Also, a label printer (not shown in the figure) forms images on labeling paper in accordance with the identification code that has been transmitted from lab server 5 (S1034). The images formed here contain the transmitted identification code, personal information, order data, the reception date and time, the processing date and time, etc. Labeling paper with images formed thereon is attached to a print-out storage bag called “DP bag.”

After the identification code or the graphics corresponding to this code has been read by inspection unit 517 (S103), if logical linkage between the read identification code and order data is confirmed in S1036, the print-out of the corresponding images by color printer portion 513 will be stored into the DP bag having the attached labeling paper corresponding to that identification code, and then packed by a packing machine (S0137). If, in S1036, the read identification code and order data are not found to be logically linked, the print-out will be given away (S1039) and processing will return to S1032. When packing is completed, An “end-of-printing” signal will be issued to lab server 5 (S1038) to terminate the processing of the lab printer 51.

After lab server 5 has received the “end-of-printing” signal, a code equivalent to “Printing Completed” will be transmitted together with the identification code (CU code or reception ID) from the lab server to center server 4 (S1007). Next after center server 4 has received the codes (S1051), the order processing status corresponding to the identification code will be changed to “Printing Completed” by center sever 4 (S1052).

When the packed print-out (DP bag) is shipped from lab 5 (S1008), the identification code (CU code or reception ID) and a code equivalent to “Shipped” will be transmitted from lab server 5 to center server 4 (S1009) and processing will be terminated.

After center server 4 has received “Shipped” (S1053), the order processing status corresponding to the identification code will be changed to “Now in Transit” by center sever 4 (S1054).

On the arrival of the packed print-out (DP bag) at the agent who was specified by the user when the print order was placed, the CU code and a code equivalent to “Delivered” are transmitted from the information terminal (for example, POS register) of the agent to center server 4 (S1061) and the order processing status corresponding to the identification code (CU code or reception ID) will be changed to “Delivered” by center sever 4 (S1055 and S1056). Also, electronic mail will, in S1057, be sent to the customer (the user who ordered) to report that the print-out has arrived at the agent.

Although telephone or other communications means can be used, instead of electronic mail, to report the above to the user, the use of electronic mail is preferred because labor can be saved by automatically issuing the above report as the trigger indicating that the status has been changed to “Delivered”, and because failure to report in the event of human intervention can be avoided.

At the agent, the user receives the print-out (DP bag) in exchange for the CU code or reception ID that was used during the image upload operations. The CU code can be presented using either a method in which the CU code stored within digital camera 1 is to be referred to by establishing connection to the terminal (image data upload apparatus 2) of the receiving agent, a method in which the CU code is to be referred to by displaying it on the liquid crystal display screen of digital camera 1, a method in which the CU code that was written onto the memory card by digital camera 1 is to be read and referred to at the terminal of the receiving agent, a method in which the CU data is to be referred to orally or in writing, or other methods.

If a CU code is not used and a reception ID is used, the reception ID that was reported to the user in S804 can be confirmed using the corresponding IC card, the required paper on which the image data has been printed out, or the like.

At the time of completion of print-out receipt and payment of charges by the user (S162), a code equivalent to “Transaction Completed” is transmitted, together with the CU code or the reception ID, from the terminal of the receiving agent to center server 4 (S1063), and after this, the order processing status corresponding to the received identification code is changed to “Transaction Completed” by center server 4 (S1058 and S1059) and all print service processing in the present invention is completed.

Although the above description applies to the case that one user places one order at a time using one digital camera, one user may actually place more than one print order. If this is the case, since logical linkage to image data cannot be established with one CU code only, it is also possible to provide the required number of CU codes (say, 100) beforehand for one digital camera and change each CU code each time the image data is to be uploaded using image data upload apparatus 2. In this case, if the required number of CU codes is exceeded, the first CU code will be used. If this CU code is still placed under the management of center server 4, however, a reception ID will be issued automatically.

It is also possible for the double use of the same CU code to be avoided by adding such information that enables the identification of the same CU code even in the event of reappearance (for example, the date and time the image data was uploaded, a sub-number, and other information) and managing CU codes. Furthermore, in S928 of FIG. 9, when an print order is placed, the charge corresponding to the type of print order can be calculated by extracting a specific code (for example, the vendor ID) included in the CU code and then selecting the charge table data corresponding to that vendor ID, from the charge data area (not shown in the figure) within the center memory unit of center server 4. In this case, the calculated charge is printed on a label by the lab printer in S1034 of FIG. 10, and the charge that has been calculated at the agent is received from the customer. At this time, charge table data can also be selected on the basis of the date acquired from the clock (not shown in the figure) in addition to the specific code included in the CU code.

Hereby, the charges on the customers who purchased specific models of digital cameras can be discounted for only a limited period at rates different from those of other customers.

According to the printing system and print service methods of the present invention, the individual unit identification information of each piece of image capturing apparatus and the image data stored within the image capturing apparatus can be logically linked and print orders can undergo processing. For example, when print orders are to be received, therefore, it is possible to execute print order processing only with the above-mentioned individual unit identification information and thus to process print orders easily and process these orders.

According to the image capturing apparatus of the present invention, individual unit identification information is stored so as to enable its output. For example, when print orders are to be received, therefore, it is possible to execute print order processing only with the above-mentioned individual unit identification information and thus to receive print orders easily and process these orders.

According to the print service processing apparatus and print service processing methods of the present invention, the individual unit identification information prestored within image capturing apparatus can be read out, then logically linked to the image data stored within the image capturing apparatus, and transmitted to other information processing apparatus present on the network. For example, when print orders are to be received via the Internet, therefore, it is possible to execute print order processing only with the above-mentioned individual unit identification information and thus to receive print orders easily and process these orders.

According to the print service administration apparatus and print service administration methods of the present invention, the individual unit identification information including provider identification information and independent manufacturing identification information is stored together with image data in logically linked form. For example, when image data is to be viewed via the Internet, therefore, it is possible to execute print service processing only with the above-mentioned individual unit identification information and to supply beneficial advertisement information to the user logically linked to the above-mentioned provider identification information.

According to the print processing apparatus and print processing methods of the present invention, the individual unit identification information including provider identification information and independent manufacturing identification information, and images based on image data undergo processing to form the final images. For example, when print orders are to undergo processing, therefore, it is possible to execute processing only with the above-mentioned individual unit identification information and thus to receive print orders easily and process these orders.

What is claimed is:

1. A data printing system, comprising:
an image capturing apparatus, including a memory for storing individual unit identification information of said image capturing apparatus;
a print service administration apparatus, connected to a network, for administering image data printing and for receiving image data recorded by said image capturing apparatus; and
a print processing apparatus, connected to said network, for executing a printing process in accordance with an instruction from said print service administration apparatus;
wherein said individual unit identification information and said image data are transmitted from said image capturing apparatus to said print service administration apparatus; and said printing process by said print processing apparatus is administered by establishing a logical linkage between said individual unit identification information and said image data.

2. The data printing system of claim 1, wherein said print service administration apparatus administers said printing process in accordance with said image data and corresponding order receiving ID.

3. The data printing system of claim 1, wherein said print service administration apparatus includes a means for notifying to a user of said printing system a ready state to provide a printed copy of said image data.

4. The data printing system of claim 1, wherein said individual unit identification information includes provider identification information and independent manufacturing information.

5. The data printing system of claim 4, wherein said provider identification information and said independent manufacturing information are those defined in USB 2.0 standards.

6. The data printing system of claim 1, wherein said image data is stored in an image data recording area of a data file and said individual unit identification information is stored either in a header part or in a job descriptor part of said data file.

7. The data printing system of claim 6, wherein said image data and said individual unit identification information are stored in said data file in accordance with DPOF standards.

8. The data printing system of claim 6, wherein at least a part of said individual unit identification information is stored in a vendor unique portion of said job descriptor part.

9. The data printing system of claim 1, wherein said image data is stored in an image data recording area of a data file and said individual unit identification information is stored in a tag portion of a data file.

10. The data printing system of claim 9, wherein said image data and said individual unit identification information are store in said data file in accordance with Exif standards.

11. An image capturing apparatus, comprising:
a memory for storing individual unit identification information, being unique to each of said image capturing apparatus; and
a transmission means for transmitting said individual unit identification information in said memory to an external information processing apparatus.

12. The image capturing apparatus of claim 11, comprising:
a receiving means for receiving a request signal of said individual unit identification information from said external information processing apparatus; and
a control means for controlling said transmission means so as to transmit said individual unit identification information to said external information processing apparatus in response to said request signal.

13. The image capturing apparatus of claim 11, comprising:
a power receiving means for receiving electric power from said external information processing apparatus;
wherein at least said transmission means is operable by electric power received from said external information processing apparatus.

14. The image capturing apparatus of claim 11, comprising:
a transmission state selection means for switching a state of transmission of said individual unit identification information between transmissible and not-transmissible.

15. The image capturing apparatus of claim 11, comprising:
a display means for displaying said individual unit identification information.

16. The image capturing apparatus of claim 11, wherein said individual unit identification information includes provider identification information and independent manufacturing information of said image capturing apparatus.

17. The image capturing apparatus of claim 11, wherein said memory stores at least a first individual unit identification information and a second individual unit identification information; and said image capturing apparatus comprises:
an identification information selection means for selecting one of said first individual unit identification information and said second individual unit identification information as said individual unit identification information.

18. An image capturing apparatus, to which a memory media is attachable, comprising:
a memory for storing individual unit identification information, being unique to each of said image capturing apparatus;
an image data recording means for recording image data captured by said image capturing apparatus and stored in said memory; and
an writing means for writing said individual unit identification information onto said memory media.

19. The image capturing apparatus of claim 18, wherein said image data is stored in a recording area in said memory media; and said individual unit identification information is stored either in a header part or in a job descriptor part of said data file.

20. The image capturing apparatus of claim 19, wherein at least a part of said individual unit identification information is stored in a vendor unique portion of said job descriptor part.

21. The image capturing apparatus of claim 18, wherein said image data is stored in a recording area in said memory media; and said individual unit identification information is stored in a tag portion of said data file.

22. The image capturing apparatus of claim 18, comprising:
a storage state selection means for switching a state of writing of said individual unit identification information by said writing means between writable and not-writable.

23. A print service reception processing apparatus, capable of a communication with an image capturing apparatus, comprising:
an image data upload means for reading image data stored in said image capturing apparatus;
an identification information reading means for reading individual unit identification information which is stored in said image capturing apparatus; and
a transmission means for transmitting said image data and said individual unit identification information through a network.

24. The print service reception processing apparatus of claim 23, wherein said print service reception processing apparatus requests said image capturing apparatus to transmit said individual unit identification information.

25. The print service reception processing apparatus of claim 23, wherein said print service reception processing apparatus executes a process to relate said image data to said individual unit identification information.

26. The print service reception processing apparatus of claim 23, comprising:
a display means for displaying an image in accordance with said image data read by said image data upload means;
an image selection input means for inputting a selection of an image from images displayed in said display means;
an order input means for inputting a print order of said image selected by said image selection input means; and
an order information generation means for generating a piece of order information which is related to said individual unit identification information in accordance with said print order;
wherein said transmission means transmits said order information to other information processing apparatus.

27. A print service reception processing apparatus, capable of coupling with a memory media in which image data is stored, comprising:
an image data reading means for reading image data stored in said memory media;
an identification information reading means for reading individual unit identification information which is stored in said memory media; and
a transmission means for transmitting said image data and said individual unit identification information through a network.

28. A print service administration apparatus, comprising:
an identification information receiving means for receiving individual unit identification information of an image capturing apparatus owned by a customer;
an image data receiving means for receiving image data of said image capturing apparatus; and
an image data storing means for storing said image data in relation to said individual unit identification information.

29. The print service administration apparatus of claim 28, wherein said individual unit identification information includes provider identification information and independent manufacturing identification information.

30. The print service administration apparatus of claim 28, comprising:
an access ID receiving means for receiving an access ID transmitted from a client terminal which is connected to a network;
a comparison means for comparing said access ID with said individual unit identification information and for generating a comparison result; and
an access restriction means for restricting an access from said client terminal in accordance with said comparison result.

31. The print service administration apparatus of claim 28, comprising:
an image data generation means for generating display image data for display in accordance with said image data received by said image data receiving means; and
a display image transmission means for transmitting said display image data.

32. The print service administration apparatus of claim 29, comprising:
an advertisement information memory means for storing advertisement information;
a display advertisement information generation means for generating display advertisement information for display in accordance with said provider identification information and said advertisement information; and
a display advertisement information transmission means for transmitting said display advertisement information.

33. The print service administration apparatus of claim 28, comprising:
a personal information receiving means for receiving personal information; and
a personal information memory means for storing said personal information in relation to said individual unit identification information.

34. The print service administration apparatus of claim 28, comprising:
a print order information receiving means for receiving print order information of said image data; and
a print order information memory means for storing said print order information in relation to said individual unit identification information.

35. The print service administration apparatus of claim 34, comprising:
a print order processing state memory means for storing a print order processing state in accordance with said print order information in relation to said individual unit identification information; and
a print order processing state transmission means for transmitting said print order processing state in response to a reference request with said individual unit identification information.

36. A print processing apparatus, comprising:
an identification information receiving means for receiving individual unit identification information of an image capturing apparatus owned by a customer;
an image data receiving means for receiving image data which has a relationship with said individual unit identification information;
a first image forming means for forming an image in a memory medium in accordance with said image data; and
a second image forming means for recording said individual unit identification information in said memory medium or for forming an image in said memory medium in correspondence with said individual unit identification information.

37. The print processing apparatus of claim 36, wherein said individual unit identification information includes provider identification information and independent manufacturing identification information.

38. The print processing apparatus of claim 36, comprising:
an advertisement information memory means for storing advertisement information which is in relation to provider identification information of said individual unit identification information; and
an advertisement image selection means for selecting advertisement image data in correspondence with said provider identification information;
wherein said first image forming means forms an image in accordance with said advertisement image data selected by said advertisement image selection means.

39. The print processing apparatus of claim 36, comprising:
an individual unit identification information detection means for detecting said individual unit identification information in accordance with said individual unit identification information, stored in said memory medium, or said image, formed in said memory medium in correspondence with said individual unit identification information; and
a recording medium processing means for processing said recording medium, in which said image is formed, in accordance with said individual unit identification information detected by said individual unit identification information detection means.

40. A data file configured to include an image data in relation to the information comprising:
image data captured by an image capture apparatus; and
individual unit identification information being unique to each of said image capture apparatus;
wherein said individual unit identification information corresponds to said image data.

41. A memory medium wherein said data file of claim 40 is stored.

42. The memory medium of claim 41, wherein said memory medium is an image information memory means in a print service administration apparatus to administer image data of a customer.

43. The memory medium of claim 41, wherein said memory medium is capable of being coupled with said image capturing apparatus.

44. The data file of claim 40, wherein said individual unit identification information is stored as a header portion or a tag portion of said image data.

45. The data file of claim 40, wherein said individual unit identification information is stored as a file in correspondence with said image data.

46. A memory medium for storing an image data in relation to the information comprising:
image data captured by an image capture apparatus; and
individual unit identification information being unique to each of said image capture apparatus;
wherein said individual unit identification information corresponds to said image data.

47. The memory medium of claim 46, wherein said memory medium is an image information memory means in a print service administration apparatus to administer image data of a customer.

48. The memory medium of claim 46, wherein said memory medium is capable of being coupled with said image capturing apparatus.

49. A print service method in use with a network to which there are connected an image capturing apparatus for capturing and recording image data; a print service administration apparatus for administering a print process of said image data; and a print processing apparatus for printing an image in response to a command from said print service administration apparatus, comprising the steps of:
transmitting said image data, captured and recorded by said image capturing apparatus, and individual unit identification information, being unique to each of said image capturing apparatus, to said print service administration apparatus in which said image data and said individual unit identification information are related to each other;
storing information, which is sent from said image capturing apparatus, into said print service administration apparatus; and
transmitting said image data, corresponding to said individual unit identification information, from said print service administration apparatus to said print processing apparatus when said print service administration apparatus receives said individual unit identification information together with a printing order.

50. The print service method of claim 49, wherein a print service reception processing apparatus for uploading said image data to said print service administration apparatus is connected to said network; and said print service reception processing apparatus transmits said image data, captured and stored by said image capturing apparatus, and said individual unit identification information to said print service administration apparatus in which said image data and individual unit identification information are related to each other.

51. The print service method of claim 49, comprising the step of:
notifying to a user of said print service method a ready state to provide a printed copy of said image data.

52. A print service method for forming an image in accordance with image data captured by an image capturing apparatus, comprising the steps of:
reading individual unit identification apparatus, being unique to each of said image capturing apparatus and preloaded to said image capturing apparatus;
reading said image data, captured by said image capturing apparatus and stored therein;
relating said individual unit identification apparatus to said image data;
storing said image data related to said individual unit identification apparatus;
selecting a piece of image data from said image data stored by said storing step of image data;
inputting a printing order of said selected piece of image data;
generating order information in relation to said individual unit identification information in accordance with said printing order inputted by said inputting step;
forming an image in a recording medium in accordance with said image data and said order information; and
recording said individual unit identification information or said image, in correspondence with said individual unit identification information, in said recording medium.

53. A print service reception processing method in use with a print service reception processing apparatus which is connected to a network, comprising the steps of:
reading image data which is captured by an image capturing apparatus;
reading individual unit identification information, being unique to each of said image capturing apparatus and preloaded to said image capturing apparatus; and
transmitting said image data and said individual unit identification information through said network.

54. The print service reception processing method of claim 53, wherein said print service reception processing apparatus reads said image data and said individual unit identification information by communicating with said image capturing apparatus.

55. The print service reception processing method of claim 54, comprising the step of:
requesting to said image capturing apparatus a transmittance of said individual unit identification information.

56. The print service reception processing method of claim 53, wherein said print service reception processing apparatus is capable of being coupled with a memory medium; and said print service reception processing apparatus reads said image data and said individual unit identification information which are stored in said memory medium.

57. The print service reception processing method of claim 53, comprising the step of:
relating said image data to said individual unit identification information.

58. The print service reception processing method of claim 53, comprising the steps of:
displaying images in accordance with said image data;
inputting a selection of an image from said images;
inputting a print order of said image selected by said selection;
generating order information in relation to said individual unit identification information in accordance with said print order; and
transmitting said order information.

59. A print service administration method in use with a print service administration apparatus which is connected to a network, comprising the steps of:
receiving individual unit identification information of an image capturing apparatus owned by a customer;
receiving image data from said image capturing apparatus; and
storing said image data in relation to said individual unit identification information.

60. The print service administration method of claim 59, comprising the steps of:
receiving an access ID transmitted from a client terminal which is connected to said network;
comparing said access ID with said individual unit identification information and for generating a comparison result; and
restricting an access from said client terminal in accordance with said comparison result.

61. The print service administration method of claim 59, comprising the steps of:
generating display image data for display in accordance with said image data received by said image data receiving means; and
transmitting said display image data.

62. The print service administration method of claim 59, wherein said individual unit identification information includes provider identification information, comprising the steps of:
generating display advertisement information for display in accordance with said provider identification information and said advertisement information; and
transmitting said display advertisement information.

63. The print service administration method of claim 59, comprising the steps of:
receiving personal information; and
storing said personal information in relation to said individual unit identification information.

64. The print service administration method of claim 59, comprising the steps of:
receiving print order information of said image data; and
storing said print order information in relation to said individual unit identification information.

65. The print service administration method of claim 64, comprising the steps of:
storing a print order processing state in accordance with said print order information in relation to said individual unit identification information; and
transmitting said print order processing state in response to a reference request with said individual unit identification information.

66. A print processing method, comprising the steps of:
receiving individual unit identification information of an image capturing apparatus owned by a customer;
receiving image data which has a relationship with said individual unit identification information;
forming an image in a memory medium in accordance with said image data; and
recording said individual unit identification information in said memory medium or for forming an image in said memory medium in correspondence with said individual unit identification information.

67. The print processing method of claim 66, comprising the steps of:
selecting advertisement image data in correspondence with provider identification information which is included in said individual unit identification information;
forming an image in accordance with said advertisement image data selected by said step of selecting said advertisement image data.

68. The print processing method of claim 66, comprising the steps of:
detecting said individual unit identification information in accordance with said individual unit identification information, recorded in said memory medium, or said image, formed in said memory medium in correspondence with said individual unit identification information; and
processing said recording medium, in which said image is formed, in accordance with said individual unit identification information detected by said step of detecting said individual unit identification information.
